(19) United States
(12) Patent Application Publication
(10) Pub. No.: US 2008/0040096 A1
(43) Pub. Date: Feb. 14, 2008

(54) Machine Translation System, A Machine Translation Method And A Program

(75) Inventors: Seiya Osada, Tokyo (JP); Kiyoshi Yamabana, Tokyo (JP)

Correspondence Address: FOLEY AND LARDNER LLP;SUITE 500, 3000 K STREET NW, WASHINGTON, DC, 20007, US

(73) Assignee: NEC CORPORATION

(21) Appl. No.: 10/593,049

(22) PCT Filed: Mar. 7, 2005
(86) PCT No.: PCT/JP05/03847

§ 371 Date: Sep. 15, 2006

(30) Foreign Application Priority Data
Mar. 18, 2004 (JP) 2004-079080

(51) Int. Cl. G06F 17/28

(52) U.S. Cl. 704/3; 704/E15.001

(57) ABSTRACT

In machine translation and automatic interpretation processing, it is possible to appropriately translate proper nouns not registered to a dictionary. The proper noun dictionary data generating means 21 generates proper noun user dictionary data according to a predetermined rule using proper nouns in a target language kept in the proper noun storage section 31. The generated proper noun user dictionary data is stored in the proper noun user dictionary storage section 32. The proper noun user dictionary is outputted to the output device 4 at any time to be referred to when a translation object sentence is inputted. The machine translation means 22 conducts translation using, in addition to the machine translation dictionary, the proper noun user dictionary stored in the proper noun user dictionary storage section 32.

### TECHNICAL FIELD

The present invention relates to a machine translation (automatic interpretation) system, a machine translation (automatic interpretation) method, and a machine translation (automatic interpretation) program, and in particular, to those superior in the handling of proper nouns.

### BACKGROUND ART

As an application example of a machine translation/automatic interpretation system, there exists a regional proper noun dictionary receiving system disclosed by the present applicant in Japanese Patent Laid-Open No. 2003-330916. According to the publication, the regional proper noun dictionary receiving system includes a portable terminal device including a position detecting function to detect a geographical current position of the terminal and a server including a database of regional proper noun dictionaries in which information including pronunciation information associated with regionally unique nouns is described. According to the publication, the portable terminal device first transmits positional information obtained by the position detecting function to the server by use of a transmission function. When the positional information is received from the portable terminal device, the server conducts matching between the positional information and regional proper noun dictionaries to select a regional proper noun dictionary suitable for the positional information, and then downloads dictionary data thus selected to the portable terminal device. Then, the portable terminal device outputs a regional proper noun using the dictionary data obtained from the server. The regional proper noun dictionary receiving system can be used not only in our country but also in countries we visit in the world to obtain a regional proper noun thereof.

Patent document 1: Japanese Patent Application Laid-Open No. 2003-330916, FIG. 1

### DISCLOSURE OF INVENTION

### Problem to be Solved by the Invention

As described above, although it is known that a machine translation/automatic interpretation system becomes more useful with a large number of dictionaries including necessary information, proper nouns contained in these dictionaries are place names, personal names, names of peculiar items, and the like employed in the language under consideration, and a translated word itself has no meaning or a translated word is only a transliteration or transcription in many cases. When energy and storage space needed to create dictionaries for these proper nouns are taken into consideration, it is unrealistic with respect to the cost, feasibility, and the like to beforehand create the dictionaries for nouns unique to every countries and regions of the world.

The present invention has been devised in consideration of the above situation and it is an object thereof to provide a machine translation automatic interpretation method capable of translating proper nouns without beforehand preparing dictionaries associated with proper nouns and a system, an apparatus, and a program for implementing the machine translation automatic interpretation method and also to provide a machine translation automatic interpretation method capable of remarkably reducing the labor and the cost for the handling of the proper nouns and a system, an apparatus, and a program for implementing the machine translation automatic interpretation method.

### Means for Solving the Problem

In accordance with a first viewpoint of the present invention providing means for solving the problem, there is provided a machine translation system in which proper noun information including proper noun groups described in a translation target language is accessed; for the proper noun information accessed as above, corresponding character strings are automatically generated in a language at least other than the target language to create a proper noun user dictionary to present the dictionary to the user; receiving an input, a corresponding character string contained in a translation objective sentence is translated into proper nouns in the target language. More specifically, the machine translation system in accordance with the present invention includes means for generating proper noun user dictionary data and creates, by the means, a proper noun user dictionary including information necessary for the machine translation using proper nouns in the target language. Additionally, more preferably, the machine translation system in accordance with the present invention includes a proper noun user dictionary storage section to store proper noun user dictionary therein. By adopting such a configuration, it is possible to create and to enhance the user dictionary for the machine translation using data including only easily attainable proper nouns in the target language to thereby translate sentences including proper nouns.

### ADVANTAGES OF THE INVENTION

In accordance with the present invention, translation/interpretation processing with a corresponding word translation function superior in proper noun translation can be executed without beforehand preparing dictionaries associated with proper nouns. More straightforwardly, since it is not required to beforehand create dictionaries for the machine translation at least for proper nouns, the cost of creation and possession of dictionaries can be reduced.

### BEST MODE FOR CARRYING OUT THE INVENTION

Subsequently, description will be given in detail of a best mode for carrying out the present invention. The machine translation system in accordance with the present invention is formed in its favorable embodiment as an information processing system including an input device (1 of FIG. 1) such as a keyboard, a machine translation apparatus, a storage section (3 of FIG. 1), and an output device (4 of FIG. 1) including a display device and a printing device.

The storage section (3 of FIG. 1) includes a target language proper noun storage section (31 of FIG. 1), a proper noun user dictionary storage section (32 of FIG. 1), and a machine translation dictionary storage section (33 of FIG. 1).

The target language proper noun storage section (31 of FIG. 1) stores therein, for one language (original language), proper nouns in another language (target language) to which the original language is converted through machine translation processing. Here, it is assumed that the target language is English and proper nouns such as “Aachen” and “Aaland” are stored.

The proper noun user dictionary storage section (32 of FIG. 1) stores therein a proper noun user dictionary for the machine translation, the dictionary corresponding to the proper nouns stored in the target language proper noun storage section (31 of FIG. 1).

The machine translation dictionary storage section (33 of FIG. 1) stores therein a fundamental dictionary to be used when the machine translation is carried out.

The machine translation apparatus includes a proper noun user dictionary data generating section (21 of FIG. 1) including programs to be executed by a central processing unit, not shown, and a machine translation section (22 of FIG. 1).

The proper noun user dictionary data generating section (21 of FIG. 1) generates the proper nouns stored in the target language proper noun storage section (31 of FIG. 1) in a dictionary data format used in the machine translation section (22 of FIG. 1) to store the data in the proper noun user dictionary storage section (32 of FIG. 1). Moreover, the data generating section (21 of FIG. 1) outputs the stored proper noun user dictionary to the output device (4 of FIG. 1).

The machine translation section (22 of FIG. 1) translates, by referring to the data in the proper noun user dictionary storage section (32 of FIG. 1) and the machine translation dictionary storage section (33 of FIG. 1), a sentence in the original language inputted from the input device (1 of FIG. 1) into the target language to provide it for the output device (4 of FIG. 1).

Next, referring to the drawings, description will be given in detail of operation of the machine translation system configured as described above. First, description will be given of operation where the machine translation system outputs a proper noun user dictionary according to the proper noun information and urges input of a translation objective sentence.

First, the proper noun user dictionary data generating section (21 of FIG. 1) of the machine translation apparatus reads in a proper noun stored in the target language proper noun storage section (31 of FIG. 1; step A1 of FIG. 2), automatically generates a corresponding character string corresponding to the proper noun (step A2 of FIG. 2), and stores the character string in the proper noun user dictionary storage section (32 of FIG. 1), the character string being associated with the proper noun. For example, when the original language is Japanese and proper nouns “Aachen” and “Aaland” are read in, the proper noun user dictionary data generating section (21 of FIG. 1) converts the respective words into phonetic symbols according to a predetermined rule to generate corresponding character strings, “ah(â)chen” and “ahrando” in the original language.

In this connection, “Aachen” and “Aaland” are generally expressed in the original language (Japanese) as “ah-hen” (city) in Germany and “ohrando” (island) in Finland. However, in the present invention, it is not required to strictly transliterate the words, which will be clarified by the explanation described later.

The proper noun user dictionary data generating section (21 of FIG. 1) of the machine translation apparatus outputs, to the output device (4 of FIG. 1), the proper nouns stored in the target language proper noun storage section (31 of FIG. 1) and the corresponding character strings stored in the proper noun user dictionary storage section (32 of FIG. 1; step A4 of FIG. 2).

In this stage, pairs of the proper nouns and the corresponding character strings of the machine translation system are displayed. The user inputs, by referring to the displayed information, a sentence including character strings corresponding to the proper nouns of the target language.

The machine translation section (22 of FIG. 1) of the machine translation apparatus reads in the machine translation dictionary from the machine translation dictionary storage section (33 of FIG. 1; step A5 of FIG. 4), and then reads the proper noun user dictionary from the proper noun user dictionary storage section (32 of FIG. 1; step A6 of FIG. 4).

Next, the machine translation section (22 of FIG. 1) of the machine translation apparatus reads the translation objective sentence inputted from the input device (1 of FIG. 1) in the original language (step A7 of FIG. 4). And the machine translation section (22 of FIG. 1) refers to the machine translation dictionary read in step A5 and the proper noun user dictionary read in step A6 and analyzes the translation object sentence inputted in step A7 according to a predetermined method to translate the sentence into the target language (step A8 of FIG. 4) and outputs it to the output device (4 of FIG. 1; step A9 of FIG. 4).

When the original language is, for example, Japanese, if a translation object sentence “ahchen ni ikitai” is inputted, the machine translation section (22 of FIG. 1) of the machine translation system outputs “I want to go to Aachen.”

As above, in accordance with the present embodiment, for at least proper nouns, items described in the target language can be accessed and be read in to thereby conduct the machine translation. Therefore, it is not required to beforehand create dictionary information for the machine translation, and the storage capacity for the dictionary information can be reduced.

### EMBODIMENT 1

Next, description will be given in detail of a first embodiment by referring to drawings. FIG. 1 is a block diagram showing a configuration of a machine translation system in accordance with the first embodiment of the present invention. The machine translation system in accordance with the embodiment is configured by installing programs which cause a personal computer to execute processes, which will be described later.

A personal computer includes a keyboard as the input device 1, a magnetic disk storage device as the storage section 3, and a display as the output device 4. Moreover, the personal computer includes a central processing unit which reads in and executes predetermined programs to function as the proper noun user dictionary data generating section 21 and the machine translation section 22. Furthermore, the magnetic disk storage device has stored the target language proper noun groups, the proper noun user dictionary, and the machine translation dictionary respectively in the target language proper noun storage section 31, the proper noun user dictionary storage section 32, and the machine translation dictionary storage section 33.

In this paragraph, description will be given on the assumption that the target language proper noun storage section 31 has stored, as the proper nouns of the target language, proper nouns such as “KAXI”, “SOSDK”, “WEKIND”, and “LIDRE”.

The proper noun user dictionary data generating section 21 includes a table to convert the target language proper nouns into phonetic symbols and phonetic characters in the original language according to the respective characters constituting each of the nouns and a connective relationship between the characters. According to the table, the data generating section 21 generates a notation (corresponding character string) in the original language according to a proper noun in the target language and stores the notation in the proper noun user dictionary storage section 32.

In the storage section 32, the notations (corresponding character strings) generated by the data generating section 21 in the original language are stored together with the notations in the target language and additionally the dictionary information necessary for the machine translation.

FIG. 2 is a flowchart to explain operation of an embodiment of the present invention. Referring to FIG. 2, operation of the machine translation system configured as above will be described; first, when a conversion processing request is received from the user and predetermined triggers such as selection of proper noun information are activated, the proper noun user dictionary data generating section 21 reads out from the target language proper noun storage section 31 proper nouns in the target language (step A1), refers to the table for the conversion to create notations (corresponding character strings) in the original language (step A2), and stores them in the proper noun user dictionary storage section 32 (step A3).

For example, the proper noun user dictionary data generating section 21 decomposes a proper noun “KAXI” in the target language to create phonetic symbols as “KA”→“ka”+“XI”→“si”, and stores the corresponding character string “kasi” in the proper noun user dictionary storage section 32 (reference is to be made to FIG. 3). Furthermore, for example, the data generating section 21 decomposes a proper noun “SOSDK” in the target language to create phonetic symbols as “SO”→“so”, “S”→“su”, “D”→“zu”, “K”→“ku” and stores the corresponding character string “sosuzuku” in the dictionary storage section 32 (reference is to be made to FIG. 3).

Next, the machine translation system displays a proper noun in the target language together with a notation (corresponding character string) of the proper noun in the original language (step A4). FIG. 3 is a diagram showing an input assistant window representing the contents generated from proper nouns in the target language. Referring to FIG. 3, notations (corresponding character strings) of the proper nouns in the original language is being displayed with proper nouns in the target language. The user selects a desired proper noun from the window or inputs a desired corresponding character string by referring to the window to create and input a translation object sentence.

FIG. 4 is a flowchart to explain operation of the machine translation system after the translation object sentence is inputted.

When a predetermined translation execution operation is conducted, the machine translation section 22 reads the machine translation dictionary and the proper noun user dictionary from the machine translation dictionary storage section 33 and the proper noun user dictionary storage section 32 respectively (step A5, step A6), and reads a translation object sentence in the original language inputted from the input device 1 (step A7). The machine translation section 22 conducts a predetermined analysis for the inputted translation object sentence and converts the sentence described in the original language into a text in the target language using the machine translation dictionary and the proper noun user dictionary (step A8). Finally, the machine translation section 22 outputs the text in the target language as the translation result to the display (step A9).

For example, assume that the user inputs from the keyboard “kono michiha sosuzuku ni tsuujite imasuka”, viewing the display (reference is to be made to FIG. 3) to which the proper nouns in the target language and the notations in the original language are displayed. The machine translation section 22 reads the respective dictionaries stored in the machine translation dictionary storage section 33 and the proper noun user dictionary storage section 32 to translate the input into a text in the target language “Does this way go to Sosdk?” and outputs it to the display.

As can be clear from the above description, in accordance with the present invention, it is possible to obtain a good translation result for proper nouns without preparing a proper noun dictionary in advance. Furthermore, in accordance with the present invention, existing proper noun information is converted into phonetic characters and phonetic symbols beforehand, and then is presented to the user to receive user's inputs, which makes it possible to identify a proper noun in the target language. Therefore, for proper nouns, a correct translation result can be produced without correctly inputting a notation in the target language, a translated word in the original language, or the like.

### EMBODIMENT 2

In the description of the first embodiment of the present invention, the proper noun user dictionary data generating section 21 includes a table to convert the target language proper nouns into phonetic symbols and phonetic characters in the original language with characters constituting each of the nouns and adjacent relationships between the characters. As a second embodiment of the present invention, description will be given of a configuration not using the table. Since the second embodiment of the present invention is substantially equal to the above first embodiment, description will be given of sections different from the first embodiment.

The proper noun user dictionary data generating section 21 of the machine translation system in accordance with the second embodiment of the present invention generates a name that is capable of uniquely identifying each proper noun according to a predetermined rule, regardless of the contents of characters of a proper noun in the target language.

For example, the data generating section 21 generates, for a set of proper nouns in the target language read out from the target language proper noun storage section 31, notations (corresponding character strings) as “Place name 1”, “Place name 2”, “Place name n”. And the data generating section 21 stores pairs in the proper noun user dictionary storage section 32 and displays them on the display.

FIG. 5 is another diagram representing an input assistant window indicating the contents generated from proper nouns in the target language and displayed in the window. Assume the situation where the user inputs, viewing the display on which the sub-window exemplified in FIG. 5 is presented, “kono michiha Place name 2 ni tsuujite imasuka” from the keyboard. The machine translation section 22 refers to the respective dictionaries stored in the machine translation dictionary storage section 33 and the proper noun user dictionary storage section 32 to translate the sentence into a text “Does this way go to Sosdk?” in the target language and then outputs it to the display.

As can be seen from the above description, the present invention does not necessarily require the table to generate the proper noun user dictionary data, but it is only necessary that the proper nouns in the target language can be displayed for the user to identify them. Therefore, when compared with the first embodiment described above, the second embodiment is realized in a simpler process, and it is possible to construct the system having a high processing speed at a low cost. Furthermore, when the user is not familiar with the phonetic characters and the phonetic symbols, though reading or inputting may be difficult, a correct translation result can be produced for the proper noun under consideration as described above. That is, the system generates notations (corresponding character strings) such as “place name n”, “Point n”, and “Destination n” for the user and receives user's input.

### EMBODIMENT 3

Next, description will be given of a third embodiment as a modification of the first embodiment of the present invention described above. The third embodiment of the present invention is constructed as shown in FIG. 6 and is substantially equal to the first embodiment excepting that an electronic map storage section 34 is disposed in place of the target language proper noun storage section 31 of the first embodiment. The new section will now be described.

The electronic map storage section 34 of the embodiment has stored therein, in addition to a map image, map information to display proper nouns such as place names, traffic facility names, and street names at predetermined positions.

The proper noun user dictionary data generating section 21 generates, for each proper noun included in the map information of the electronic map storage section 34, a notation (corresponding character string) in the original language as in the first embodiment. And the data generating section 21 stores pairs of notations and proper nouns in the proper noun user dictionary storage section 32 and displays them on the electronic map.

FIG. 7 is a diagram showing an input assistant window displaying an electronic map generated from map information and proper nouns included therein. Assume in this situation that the user inputs “sosuzuku ni ikitai” from the keyboard, viewing the display presenting the sub-window exemplified in FIG. 7. The machine translation section 22 refers to the respective dictionaries stored in the machine translation dictionary storage section 33 and the proper noun user dictionary storage section 32 to translate the input into a text in the target language “I want to go to Sosdk” and outputs it to the display.

As can be clear from the above description, in accordance with the present embodiment, it is possible to effectively use, as a translation dictionary, the map including proper nouns. For example, even if place names, traffic facility names, street names, and the like of the electronic map information, an electronic route map, and a street map are indicated in a particular language (target language) and the user cannot understand the place names and the like in the language, it is possible as described above to display on the map the corresponding character strings which can be inputted by the user and hence instructions can be received. This means that an electronic map where character sections are generated in a foreign language or the like and products of applications of the map (map information system; GIS, car navigation system, etc.) can be easily modified for the user who cannot understand the foreign language.

Moreover, as in the second embodiment described above, the proper noun user dictionary data generating section 21 may generate names with which each of place name information (proper noun) can be uniquely identified according to a predetermined rule, regardless of the characters of proper nouns in the target language.

FIG. 8 is another diagram representing an input assistant window displaying an electronic map generated from map information and proper nouns included therein. Assume in this situation that the user inputs, viewing the display on which the sub-window exemplified in FIG. 8 is presented, “Place name 2 ni ikitai” from the keyboard. The machine translation section 22 refers to the respective dictionaries stored in the machine translation dictionary storage section 33 and the proper noun user dictionary storage section 32 to translate the sentence into a text “I want to go to Sosdk” in the target language and then outputs it to the display.

### EMBODIMENT 4

Next, description will be given of a fourth embodiment in which the machine translation system in accordance with the present invention acquires proper noun information via a network. FIG. 9 is a block diagram showing a configuration of the machine translation system in accordance with the fourth embodiment.

Referring to FIG. 9, the storage section 3 of the machine translation system does not include the target language proper noun storage section 31 but the machine translation apparatus includes a position designating section 23 and a communicating section 24. Furthermore, a server device 5 including a communicating section 51, a proper noun selecting section 52, and a regional proper noun database 53 is connected via a network to the machine translation system.

FIG. 10 is a flowchart to explain operation between the machine translation system and the server device 5. Referring to FIG. 10, the machine translation system accesses the server device 5 through the communicating section 24, designates a desired position, using the position designating section 23, e.g., a scheduled travel destination and a current position (step B1), and requests transmission of proper noun information (step B2). Having received the request, the server device 5 selects, by use of the proper noun selecting section 52, proper noun information according to the designated position (step B3) and transmits the information to the machine translation system (step B4).

Having received the proper noun information, the machine translation system generates, by the proper noun user dictionary data generating section 21, proper noun user dictionary data as in the respective embodiments described above (step B5) to store the data in the proper noun user dictionary (step B6) and displays it on the display (step B7). After this point, a process of translating a translation object sentence inputted from the user is similar to that of each embodiment described above.

As can be clear from the above description, the present invention can adopt not only a configuration to use the proper noun information possessed by the machine translation system, but also a configuration in which the proper noun information on the network is downloaded and is used for the translation. For example, when the machine translation system in accordance with the present invention is mounted on a portable information terminal having a GPS function, it is possible to obtain proper noun information corresponding to the current position obtained from the GPS so that the information is stored in the proper noun user dictionary or is used. In this case, for example, it is possible to create and to use a dictionary including place names and the like of respective places in the world according to necessity. And, in the situation, it is not required to beforehand prepare dictionary data, which has been described in Japanese Patent Application Laid-Open No. 2003-330916.

### EMBODIMENT 5

Next, description will be given of a fifth embodiment in which pictures are taken and proper noun information is obtained from image data in a machine translation system. The machine translation system in accordance with the fifth embodiment of the present invention is configured as shown in FIG. 11 and is substantially equal to the first embodiment described above excepting that an imaging section 25 and a character recognizing section 26 are disposed in place of the target language proper noun storage section 31 of the first embodiment.

The imaging section 25 is image input means such as a digital camera and a scanner, and the character recognizing section 26 is means which scans an image to cut out a character string section contained in the image and which compares the section with a standard character pattern to convert it into text data in consideration of a connection state or the like according to necessity.

Description will be given of operation of the machine translation system in accordance with the present embodiment. When the predetermined triggers such as reception of a conversion processing request from the user and a translation execution request for image data are activated, the proper noun user dictionary data generating section 21 of the machine translation system acquires through the character recognizing section 26 a character string from an image obtained by the imaging section 25 to generate proper noun user dictionary data in a manner similar to that of each embodiment described above.

As can be clear from the above description, in accordance with the present invention, it is possible to photograph a map, a book, or the like including proper nouns to effectively use it as a translation dictionary. For example, a sightseeing guide map, a route map, a road map generated in a particular language (target language), its title section and index section, a guidebook, a telephone directory, or the like can be photographed and included in the proper noun user dictionary to thereafter execute the translation processing.

### EMBODIMENT 6

Next, description will be given of a sixth embodiment proposing a detailed configuration of the proper noun user dictionary data generating section 21 of the machine translation system in accordance with the present embodiment. The sixth embodiment of the present invention is constructed as shown in FIG. 12 and is similar to the first embodiment excepting that a target language audio synthesizing section 27 and an original language audio recognizing section 28 are disposed in place of the proper noun user dictionary data generating section 21 of the first embodiment.

The target language audio synthesizing section 27 is a means to produce an audio output using proper noun information stored in the target language proper noun storage section 31, and the original language audio recognizing section 28 is means which compares the audio output of the proper noun information with standard audio patterns in the original language to convert the information into text data, relationships of adjacent characters or the like being considered according to necessity, to store the data in the proper noun user dictionary storage section 32.

Description will be given of operation of the machine translation system in accordance with the present embodiment. When the predetermined triggers such as reception of a conversion processing request from the user or a translation execution request for image data are activated, the target language audio synthesizing section 27 of the machine translation system reads the proper noun information stored in the target language proper noun storage section 31 to produce an audio output. The original language audio recognizing section 28 compares the audio output of the proper noun information with standard audio patterns in the original language to convert the information into text data, relationships of adjacent characters or the like being taken account of according to necessity, and stores the data in the proper noun user dictionary storage section 32.

As above, the present invention can configure, depending on a combination of the target language and the original language, the proper noun user dictionary data generating section 21 by using an existing audio synthesizing section and an existing audio recognizing section.

Incidentally, in the embodiment described above, exemplified is an example in which the proper noun user dictionary data generating section 21 of the first embodiment is replaced by a combination of the target language audio synthesizing section 27 and the original language audio recognizing section 28; however, it is also possible to replace the data generating section 21 of the second to fifth embodiments by the target language audio synthesizing section 27 and the audio recognizing section 28.

### EMBODIMENT 7

Next, description will be given of a seventh embodiment in which the present invention is applied to an automatic interpretation system. The embodiment is constructed as shown in FIG. 13, and the automatic interpretation system is configured by disposing an automatic interpretation section 29 in place of the machine translation section 22 of the first embodiment.

Moreover, in the present embodiment, a microphone is connected as the input device 1, first and second output devices 41 and 42 are arranged as the output devices, and a display and a speaker are respectively connected thereto.

Description will be given of operation of the automatic interpretation system in accordance with the present embodiment. Although the operation is substantially equal to that of the first embodiment, in place of the translation objective sentence input processing by the machine translation section 22 in each embodiment described above, there is executed processing in which the automatic interpretation section 22 conducts audio recognition for the audio from the microphone to detect and to translate a display item (corresponding character string) and then conducts audio synthesis in the target language to output by the speaker a result of the audio synthesis.

As above, the present invention is applicable not only to machine translation in which a character image is a primary object, but also to automatic interpretation in which voice and sound are primarily communicated. Furthermore, it is also possible to replace the machine translation section 22 of the embodiments 2 to 6 and the sixth embodiment with the automatic interpretation section 29.

Description has been given of the respective embodiments to which the present invention is applied as above; however, the machine translation/automatic interpretation system and the machine translation/automatic interpretation method in accordance with the present invention are usable, according to the principle and the effect thereof, not only for machine translation/automatic interpretation in a narrow sense, but also for various user interfaces including conversion processing similar to them. Therefore, the present invention is not limited to the machine translation system in a narrow sense and a program for the same, but also is applicable to various terminals, servers, and devices which can execute the machine translation method and the automatic interpretation method in accordance with the present invention.

### BRIEF DESCRIPTION OF THE DRAWINGS

FIG. 1 Block diagram showing a configuration of a machine translation system in accordance with the first embodiment of the present invention.

FIG. 2 Flowchart to explain operation of the machine translation system in accordance with the first embodiment of the present invention.

FIG. 3 Diagram to explain the first embodiment of the present invention.

FIG. 4 Flowchart to explain operation of the machine translation system in accordance with the first embodiment of the present invention.

FIG. 5 Diagram to explain the second embodiment of the present invention.

FIG. 6 Block diagram showing a configuration of a machine translation system in accordance with the third embodiment of the present invention.

FIG. 7 Diagram to explain the third embodiment of the present invention.

FIG. 8 Another diagram to explain the third embodiment of the present invention.

FIG. 9 Block diagram showing a configuration of a machine translation system in accordance with the fourth embodiment of the present invention.

FIG. 10 Flowchart to explain operation of the machine translation system in accordance with the fourth embodiment of the present invention.

FIG. 11 Block diagram showing a configuration of a machine translation system in accordance with the fifth embodiment of the present invention.

FIG. 12 Block diagram showing a configuration of a machine translation system in accordance with the sixth embodiment of the present invention.

FIG. 13 Block diagram showing a configuration of a machine translation system in accordance with the seventh embodiment of the present invention.

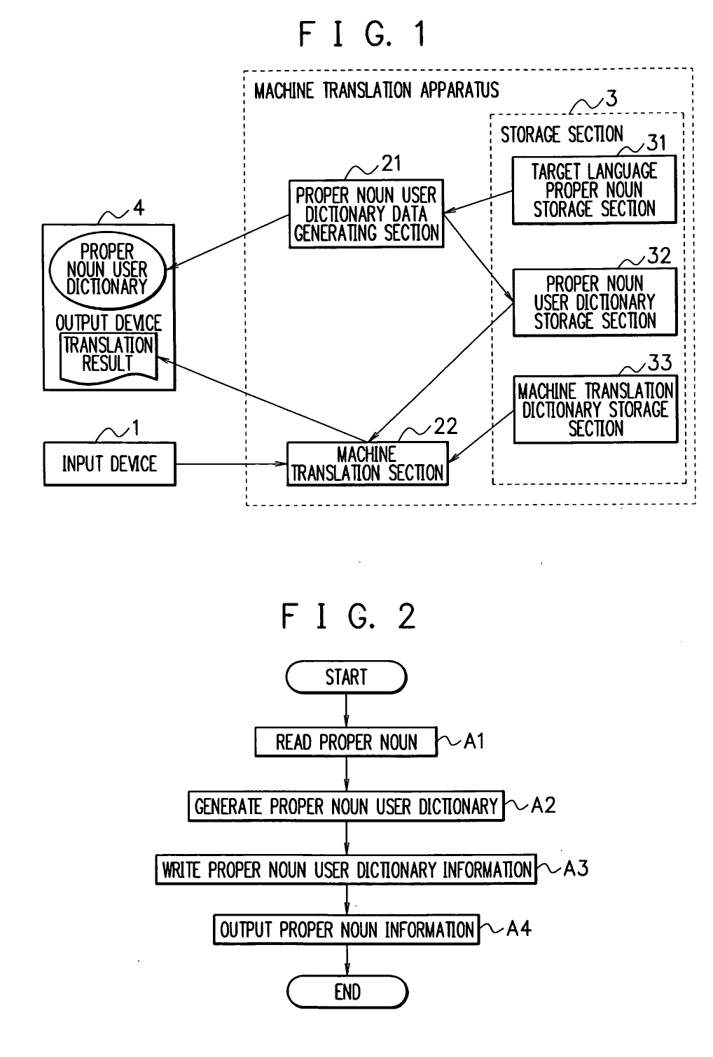

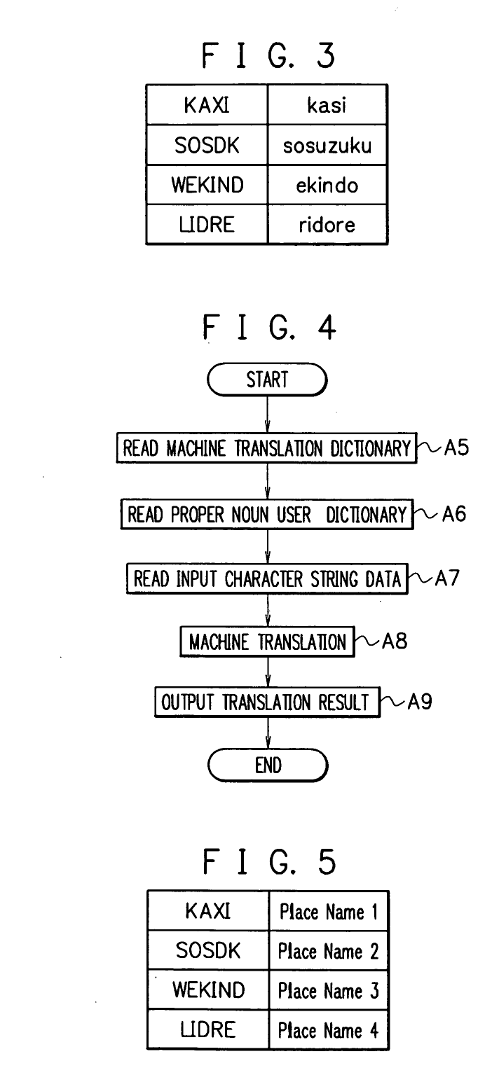

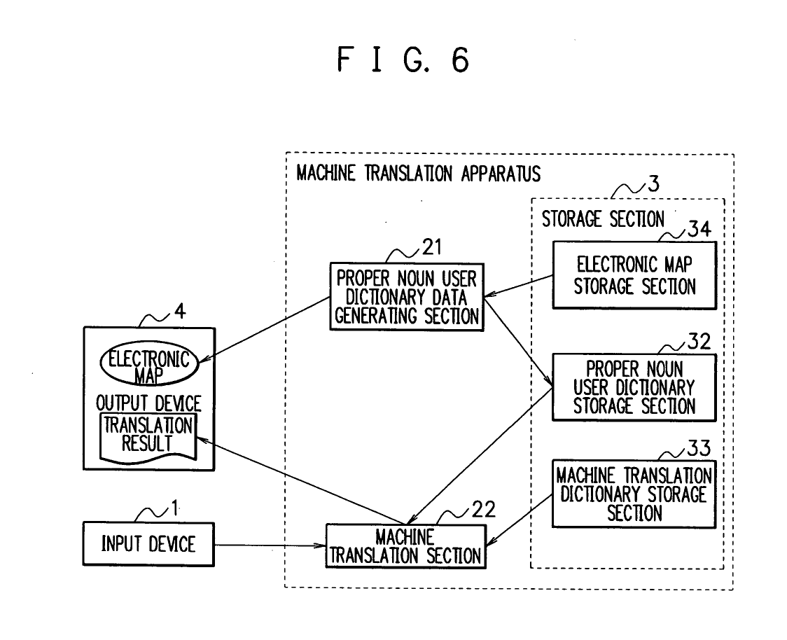

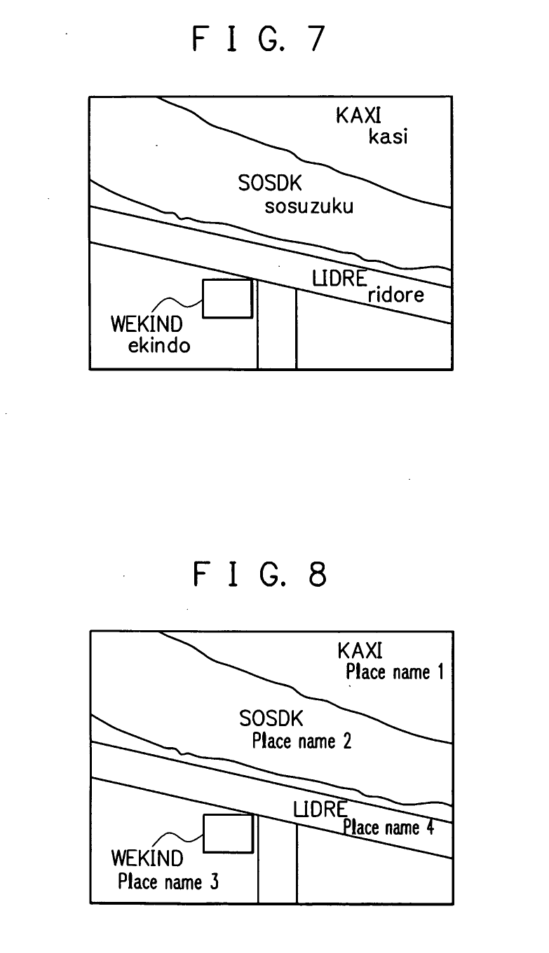

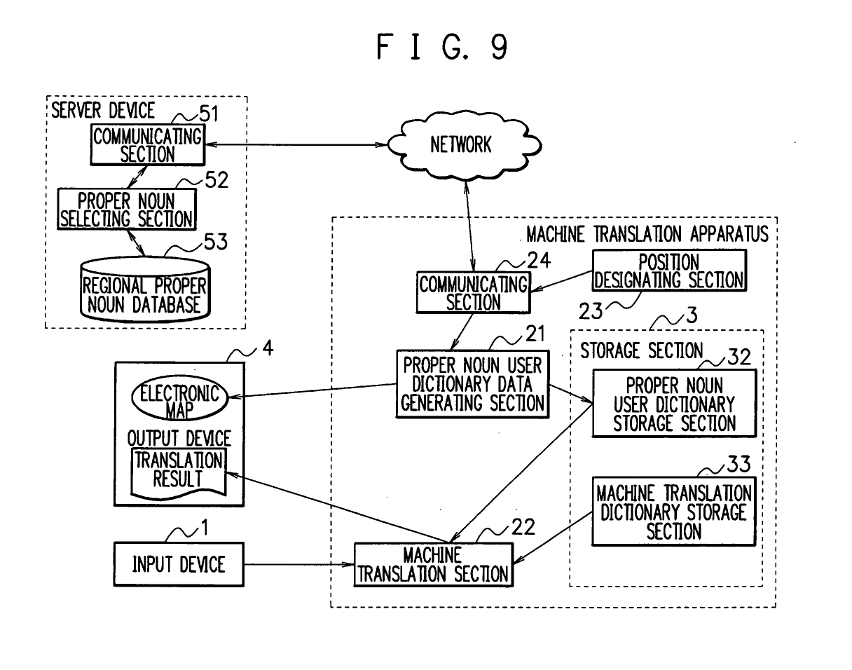

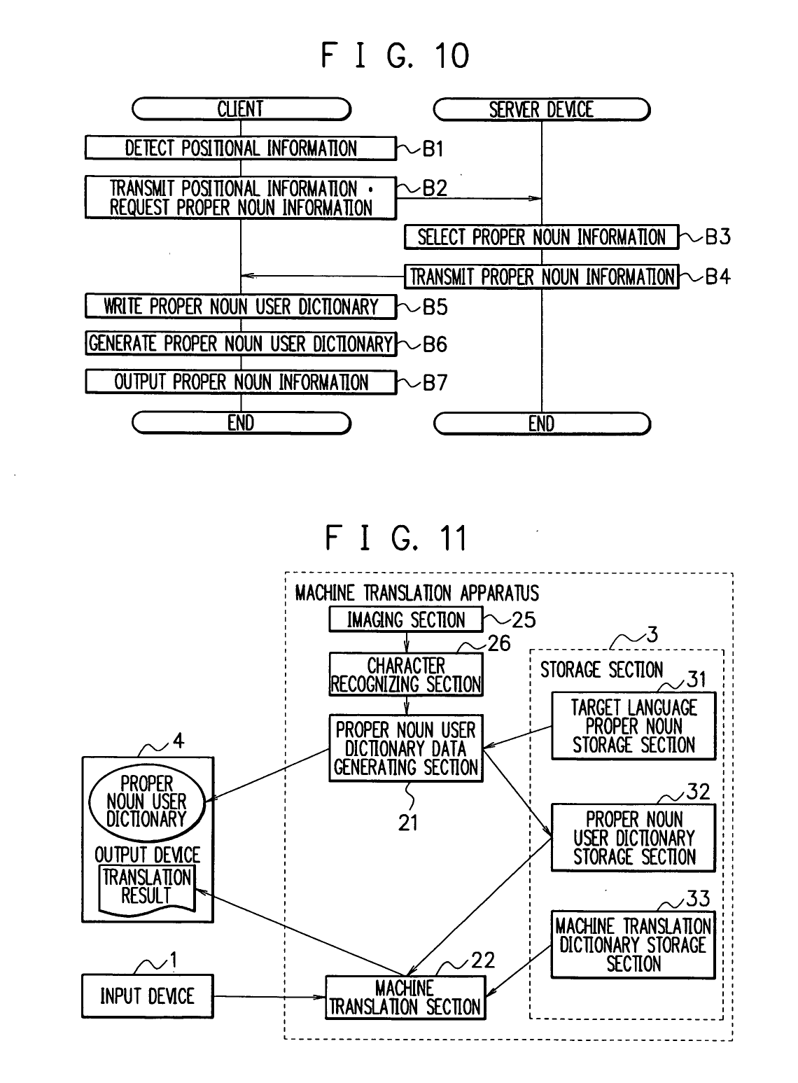

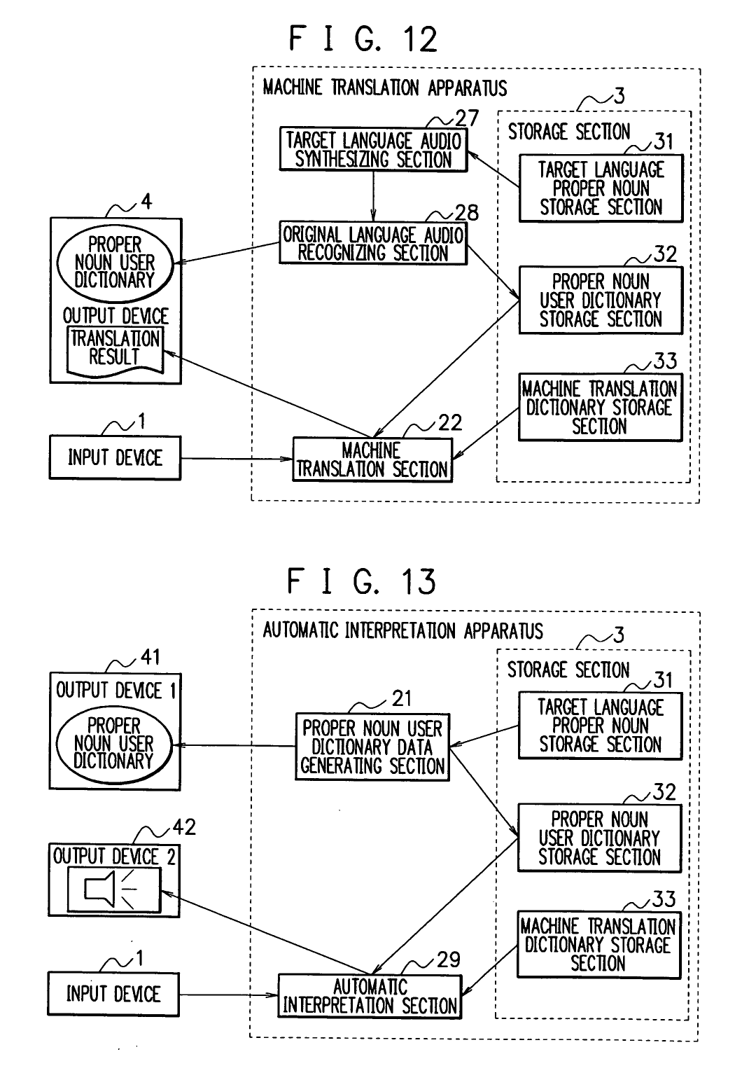

### DESCRIPTION OF REFERENCE NUMERALS

1 Input device
3 Storage section
4, 41, 42 Output device
5 Server device
21 Proper noun user dictionary data generating section
22 Machine translation section
23 Position designating section
24 Communicating section
25 Imaging section
26 Character recognizing section
27 Target language audio synthesizing section
28 Original language audio recognizing section
29 Automatic interpretation section
31 Target language proper noun storage section
32 Proper noun user dictionary storage section
33 Machine translation dictionary storage section
34 Electronic map storage section
51 Communicating section
52 Proper noun selecting section
53 Regional proper noun database

1. A machine translation system mechanically translating a sentence inputted in a first language into a second language, comprising:
a proper noun identification notation generating section for generating a notation to identify a proper noun described in the second language;
a pair display section for displaying a pair including the proper noun and the notation; and
a machine translation section for translating by converting, when the notation is included in the inputted sentence, the notation to the proper noun.

2. A machine translation system in accordance with claim 1, comprising:
a user dictionary; and
a proper noun user dictionary storage section for storing and keeping, in the user dictionary as a pair of parallel translation, the proper noun and the notation to identify the proper noun generated at the proper noun identification notation generating section;
wherein the machine translation section translates the inputted sentence by using the user dictionary.

3. A machine translation system in accordance with claim 1, wherein:
the proper noun identification notation generating section reads a proper noun from map information including proper nouns and automatically generates a notation to identify the proper noun; and
the pair display section outputs a map in which the notation is disposed in the vicinity of the proper noun included in the map.

4. A machine translation system in accordance with claim 1, further comprising:
an imaging section for producing an image; and
a character recognizing section for recognizing a proper noun character string in image data obtained by the imaging section, wherein
the proper noun identification notation generating section automatically generates a notation corresponding to the proper noun character string that has been recognized.

5. A machine translation system in accordance with claim 1, comprising in place of the proper noun identification notation generating section:
an audio synthesizing section for reading out a proper noun from the proper noun storage section storing proper nouns described in the second language, and synthesizing and outputting a sound corresponding to the proper noun; and
an audio recognizing section for recognizing the sound synthesized and outputted as above and automatically generating a notation to identify the proper noun.

6. A server device for supplying proper noun information to the machine translation system in accordance with claim 1, comprising:
a regional proper noun information storage section for storing therein, according to regions, proper nouns described in arbitrary one language; and
a proper noun information selecting and transmitting section for receiving positional information from the machine translation system and selectively transmitting proper noun information according to the positional information.

7. A server device, comprising, in place of the machine translation section of the machine translation system in accordance with claim 1, an automatic interpretation section for converting and outputting the notation, when the notation is included in a sound inputted thereto, into the sound of the proper noun corresponding to the notation in the second language.

8. A machine translation method using a machine translation system to mechanically translate a sentence inputted in a first language into a second language, comprising:
generating, by a proper noun identification notation generating section of the machine translation system, a notation to identify a proper noun described in the second language;
displaying, by a pair display section of the machine translation system, a pair including the proper noun and the notation; and
translating, by a machine translation section of the machine translation system, by converting, when the notation is included in the inputted sentence, the notation to the proper noun.

9. A machine translation method in accordance with claim 8, comprising:
a user dictionary in the machine translation system;
storing and keeping in the user dictionary as a pair of parallel translation, by a proper noun user dictionary storage section of the machine translation system, the proper noun and the notation to identify the proper noun generated at the proper noun identification notation generating section; and
translating, by the machine translation section, the inputted sentence by using the user dictionary.

10. A machine translation method in accordance with claim 8, wherein:
the proper noun identification notation generating section reads out a proper noun from map information including proper nouns and automatically generates a notation to identify the proper noun; and
the pair display section outputs a map in which the notation is disposed in the vicinity of the proper noun included in the map.

11. A machine translation method in accordance with claim 8, further comprising:
photographing an image by an imaging section of the machine translation system;
recognizing, by a character recognizing section of the machine translation system, a proper noun character string in the image data obtained by the imaging section; and,
generating automatically, by the proper noun identification notation generating section a notation corresponding to the proper noun character string that has been recognized.

12. A machine translation method in accordance with claim 8, comprising in place of the step of generating, by the proper noun identification notation generating section a notation to identify the proper noun described in the second language;
reading out, by an audio synthesizing section of the machine translation system, a proper noun from the proper noun storage section storing proper nouns described in the second language, and synthesizing and outputting a sound corresponding to the proper noun; and
recognizing, by the audio recognizing section of the machine translation system, the sound synthesized and outputted as above and automatically generating a notation to identify the proper noun.

13. A machine translation method in accordance with s claim 8, comprising:
transmitting, by the machine translation system, positional information to a server device comprising a regional proper noun information storage section for storing therein proper nouns described in arbitrary one language, the proper nouns being grouped according to regions; and
selectively transmitting, by the server device, proper noun information according to the positional information.

14. An automatic interpretation method for making an automatic interpretation system comprising an automatic interpretation section achieve a machine translation method in accordance with claim 8, wherein;
an input section of the automatic interpretation system receives a verbal translation object sentence; and
the automatic interpretation section of the automatic interpretation system converts and outputs the notation included in a sound inputted thereto into the sound of the proper noun corresponding to the notation in the second language.

15. A computer program for causing a computer constituting a machine translation system for machine translation from a first language to a second language to execute:
proper noun identification notation generating processing for generating a notation to identify a proper noun described in the second language;
pair display processing for displaying a pair including the proper noun and the notation; and
machine translation processing for translating by converting, when the notation is included in the inputted sentence, the notation to the proper noun.

16. A computer program in accordance with claim 15, wherein the machine translation system includes a user dictionary and the program causes the computer to further execute:
proper noun user dictionary storing processing for keeping and storing the proper noun and the notation to identify the proper noun generated at the proper noun identification notation generating section; and
machine translation processing for translating the inputted sentence according to the user dictionary.

17. A computer program in accordance with claim 15, the program causing the computer to execute:
processing, as the proper noun identification notation generating processing, for reading a proper noun from map information including proper nouns and automatically generating a notation to identify the proper noun; and
processing, as the pair display processing, for outputting a map in which the notation is disposed in the vicinity of the proper noun included in the map.

18. A computer program in accordance with claim 15, the program causing the computer to further execute:
image input processing for inputting an image; and
character recognizing processing for recognizing a proper noun character string in the image obtained by the image input processing, wherein
processing, as the proper noun identification notation generating processing, for automatically generating a notation corresponding to the proper noun character string recognized as above.

19. A computer program in accordance with claim 15, the program causing the computer to further execute:
audio synthesizing processing for reading a proper noun from the proper noun storage section storing proper nouns described in the second language, and synthesizing and outputting a sound corresponding to the proper noun, in place of the proper noun identification notation generating processing; and
audio recognizing processing for recognizing the sound synthesized and outputted as above and automatically generating a notation to identify the proper noun.

20. A computer program in accordance with claim 15, causing the computer to execute:
processing for transmitting positional information to a server device comprising a regional proper noun information storage section for storing therein proper nouns described in arbitrary one language, the proper nouns being grouped according to regions; and
processing for receiving proper noun information according to the positional information from the server device.

21. A computer program causing a computer constituting an automatic interpretation system for automatic interpretation to execute:
automatic interpretation processing, in place of the machine translation processing in accordance with claim 15, for converting and outputting notation included in a sound inputted thereto into the sound of the proper noun corresponding to the notation in the second language.

22. A machine translation system in accordance with claim 2, wherein:
the proper noun user dictionary data generating section reads a proper noun from map information including proper nouns and automatically generates corresponding character strings corresponding to the proper nouns; and
the proper noun user dictionary output section outputs a map in which the corresponding character string is disposed in the vicinity of the proper noun included in the map.

23. A machine translation system in accordance with claim 2, further comprising:
an imaging section for producing an image; and
a character recognizing section for recognizing a proper noun character string in image data obtained by the imaging section, wherein
the proper noun user dictionary data generating section automatically generates a corresponding character string corresponding to the proper noun character string recognized as above.

24. A machine translation system in accordance with claim 2, comprising in place of the proper noun user dictionary data generating section:
an audio synthesizing section for reading out a proper noun from the proper noun storage section storing proper nouns described in an arbitrary original language, and synthesizing and outputting a sound corresponding to the proper noun; and
an audio recognizing section for recognizing the sound synthesized and outputted as above and automatically generating a corresponding character string corresponding to the proper noun.

25. A server device for supplying proper noun information to the machine translation system in accordance with claim 2, comprising:
a regional proper noun information storage section for storing therein, according to regions, proper nouns described in arbitrary one language; and
a proper noun information selecting and transmitting section for receiving positional information from the machine translation system and selectively transmitting proper noun information according to the positional information.

26. A server device, comprising, in place of the machine translation section of the machine translation system in accordance with claim 2, an automatic interpretation section for converting and outputting, according to the proper noun user dictionary, the corresponding character string included in a sound inputted thereto into the sound of the corresponding proper noun in the one language.

27. A machine translation method in accordance with claim 9, wherein:
the proper noun user dictionary data generating section reads out a proper noun from map information including proper nouns and automatically generates a corresponding character string corresponding to the proper noun; and
the proper noun user dictionary output section outputs a map in which the corresponding character string is disposed in the vicinity of the proper noun included in the map to guide an input of a translation object sentence including the corresponding character string.

28. A machine translation method in accordance with claim 9, further comprising:
producing, by the imaging section of the machine translation system, an image in which a proper noun described in an arbitrary original language is written; and
recognizing, by the character recognizing section of the machine translation section, a proper noun character string in the image data produced as above, wherein
the proper noun user dictionary data generating section of the machine translation system automatically generates a corresponding character string corresponding to the proper noun character string recognized as above.

29. A machine translation method in accordance with claim 9, comprising in place of the step of reading, by the proper noun user dictionary data generating section of the machine translation system, a proper noun from a proper noun storage section storing proper nouns described in arbitrary one language, and automatically generating a corresponding character string corresponding to the proper noun;
reading out, by the audio synthesizing section of the machine translation system, a proper noun from the proper noun storage section storing proper nouns described in arbitrary one language, and synthesizing and outputting a sound corresponding to the proper noun; and
recognizing, by the audio recognizing section of the machine translation system, the sound synthesized and outputted as above and automatically generating a corresponding character string corresponding to the proper noun.

30. A machine translation method in accordance with claim 9, comprising:
transmitting, by the machine translation system, positional information to a server device comprising a regional proper noun information storage section for storing therein proper nouns described in arbitrary one language, the proper nouns being grouped according to regions; and
selectively transmitting, by the server device, proper noun information according to the positional information.

31. An automatic interpretation method for making an automatic interpretation system comprising an automatic interpretation section achieve a machine translation method in accordance with claim 9, wherein;
an input section of the automatic interpretation system receives a verbal translation object sentence; and
the automatic interpretation section of the automatic interpretation system converts and outputs, according to the proper noun user dictionary, the corresponding character string included in a sound inputted thereto into the sound of the corresponding proper noun in the one language.

32. A computer program in accordance with claim 16, the program causing the computer to execute:
processing, as the proper noun user dictionary data generating processing, for reading a proper noun from map information including proper nouns and automatically generating a corresponding character string corresponding to the proper noun; and
processing, as the proper noun user dictionary output processing, for outputting a map in which the corresponding character string is disposed in the vicinity of the proper noun included in the map to guide an input of a translation object sentence including the corresponding character string.

33. A computer program in accordance with claim 16, the program causing the computer to further execute:
image input processing for inputting an image in which a proper noun described in arbitrary one language is written; and
character recognizing processing for recognizing a proper noun character string in the image produced as above, wherein
processing, as the proper noun user dictionary data generating processing, for automatically generating a corresponding character string corresponding to the proper noun character string recognized as above.

34. A computer program in accordance with claim 16, the program causing the computer to further execute:
audio synthesizing processing for reading a proper noun from the proper noun storage section storing proper nouns described in arbitrary one language, and synthesizing and outputting a sound corresponding to the proper noun, in place of the proper noun user dictionary data generating processing; and
audio recognizing processing for recognizing the sound synthesized and outputted as above and automatically generating a corresponding character string corresponding to the proper noun.

35. A computer program in accordance with claim 16, causing the computer to execute:
processing for transmitting positional information to a server device comprising a regional proper noun information storage section for storing therein proper nouns described in arbitrary one language, the proper nouns being grouped according to regions; and
processing for receiving proper noun information according to the positional information from the server device.

36. A computer program in accordance with claim 16, the program causing a computer constituting an automatic interpretation system for automatic interpretation to execute:
translation objective sentence input receiving processing for receiving an input of a translation object sentence in a voice, in place of the translation object sentence input receiving processing and the machine translation processing; and
automatic interpretation processing for converting and outputting, according to the proper noun user dictionary, the corresponding character string included in a sound inputted thereto into the sound of the corresponding proper noun in the one language.
